(19) United States
(12) Patent Application Publication
(10) Pub. No.: US 2011/0090958 A1
(43) Pub. Date: Apr. 21, 2011

(54) NETWORK ABSTRACTION LAYER (NAL)-AWARE MULTIPLEXER WITH FEEDBACK

(76) Inventors: Avinash Sridhar, Plainsboro, NJ (US); David Anthony Campana, Princeton, NJ (US); Shemimon Manalikudy Anthru, Monmouth, NJ (US)

(21) Appl. No.: 12/737,133

(22) PCT Filed: Jan. 26, 2009
(86) PCT No.: PCT/US2009/000499

§ 371 Date: Dec. 10, 2010

Related U.S. Application Data
(60) Provisional application No. 61/132,315, filed on Jun. 17, 2008.
(60) Provisional application No. 61/077,185, filed on Jul. 1, 2008.
(60) Provisional application No. 61/082,843, filed on Jul. 23, 2008.

(51) Int. Cl. H04N 7/173; H04N 7/26; H04N 7/32

(52) U.S. Cl. 375/240.12; 375/240.01; 725/116; 375/E07.026; 375/E07.243

(57) ABSTRACT

Advanced multiplexing methods and apparatus that are especially useful in multiplexing variable bit rate input video streams onto a fixed bandwidth output stream with minimum effect on video quality are described. A multiplexer provides feedback to a stagger transmitter to help it maintain its output bit rate. In addition, the stagger transmitter parses Network Abstraction Layers (NALs) from the given streams and makes decisions on which NALs to forward to the MUX.

### CROSS-REFERENCE TO RELATED APPLICATIONS

This application claims the benefit of U.S. Provisional Application No. 61/082,843 filed Jul. 23, 2008; U.S. Provisional Application No. 61/132,315, filed Jun. 17, 2008; and U.S. Provisional Application No. 61/077,185, filed Jul. 1, 2008.

### FIELD OF THE INVENTION

The present invention relates to the field of digital video transmission, and particularly to the statistical multiplexing of digital video streams.

### BACKGROUND INFORMATION

A statistical multiplexer is used in a media broadcast chain to combine multiple input streams to transmit over a single output pipe having a maximum bandwidth limit. Typically, the input streams will be of variable bit rate since the bit rates of the media encoders generating the streams will depend on variations in the sources, such as, for example, video scene changes.

Statistical multiplexers use different techniques to accommodate input streams having variable bit rates in the constant bit rate output. Most of the techniques currently used will have an impact on the quality of the stream. One of the methods used by statistical multiplexers is to divide the output communication channel into an arbitrary number of variable bit rate digital channels. Each digital channel will be allocated according to the instantaneous traffic demand of the input streams. This kind of output link sharing provides means of satisfying the variable bit rate needs of the input streams at different instants of time. If a large number of input streams are in need of high throughput at the same time, however, such link sharing often fails. In this situation, not all of the input streams will be able to get the bandwidth they require, and quality is sacrificed in order to accommodate the fixed width output.

FIGS. 1A and 1B illustrate a typical link sharing arrangement, in which a 7 Kbps output channel is divided into four logical channels having bit rates of 1 Kbps, 3 Kbps, 2 Kbps and 1 Kbps, respectively, as shown in FIG. 1B. Two variable bit rate input streams averaging 5 Kbps and 2 Kbps are shown in FIG. 1A. As illustrated, in the first cycle (0-1,000 ms) the multiplexer can make use of all four logical channels and put all input streams into the output pipe, whereas in the second cycle (1,000-2,000 ms) the input bit rate is more than the capacity of the available logical channels.

In typical broadcast systems, such as in direct broadcast satellite applications, multiple video programs are encoded in parallel, and the digitally compressed bit streams are multiplexed into a single, constant bit rate channel. The simplest multiplexing approach to this application is to divide the available channel bandwidth equally among all programs. But this method has the disadvantage that at any instant in time, the resulting quality of the video programs is uneven because of the different scene content of the programs and changes of scene content over time. The explanation for this lies in the rate-distortion theory. (See T. Berger, Rate Distortion Theory, Prentice-Hall, Inc.)

To achieve equal video quality for all programs, the available channel bandwidth should be distributed unevenly among the programs, namely, in proportion to the information content (e.g. complexity) of each of the audio/video sources. Thus the objective of statistical multiplexing is to dynamically distribute the available channel bandwidth among the video programs in order to maximize the overall picture quality of the system.

There are several methods that attempt to achieve the above-described objective, one of which is referred to as joint rate-control, which guides the operation of individual encoders based on a continuous monitoring of the scene content of each of the video sources. (See L. Boroczky et al., “Statistical multiplexing using MPEG-2 video encoders,” IBM 1999.)

There are two known ways of doing joint rate-control. One is a feedback-based approach, in which statistical measurements of video complexity are generated by the encoders as a by-product of the compression process. The statistics from all encoders are compared and used to control the bit allocation for the subsequent video. Another is a look-ahead approach, in which the complexity statistics are computed by preprocessing all video programs prior to encoding. These statistics are then used to more accurately predict the bit rate allocation needed for optimum compression of the video sources in the rate distortion sense.

There are disadvantages in joint rate-control, however. Regardless of the approach taken, joint rate-control changes the encoder bit rate dynamically at Group Of Pictures (GOP) boundaries. Joint rate-control controls each encoder individually for controlling the bit rate. In a multi-program environment where there is relative dependency between streams, (for example, a Scalable Video Coding (SVC) stream where the base and enhancement layers are related) joint rate-control does not take advantage of the relation between layers. Moreover, joint rate-control depends on the statistics produced by different approaches, but finding the best statistics to describe the complexity of a program is a challenging task.

As such, there is a need for a statistical multiplexer that can better accommodate input streams having variable bit rates with less impact on the quality of the streams.

### SUMMARY OF THE INVENTION

In an exemplary embodiment, the present invention provides a statistical multiplexing system and method in which a statistical multiplexer is in constant feedback with a stagger transmitter so that dynamic bit rate reduction can be carried out at the stagger transmitter, instead of at the encoder level.

In a further exemplary embodiment, the stagger transmitter feed-forwards information to the multiplexer about the relative importance of data units, allowing the multiplexer to decide which data units to pass or drop.

The system and method of the present invention can also take advantage of any relation between streams, as in the case of Scalable Video Coding (SVC).

Unlike most known dynamic bandwidth allocation techniques used in multiplexers which will have an impact on the video quality of the input streams, the method and apparatus of the present invention can fit variable bit rate input streams with minimum effect on video quality.

The aforementioned and other features and aspects of the present invention are described in greater detail below.

### BRIEF DESCRIPTION OF THE DRAWINGS

FIGS. 1A and 1B illustrate a conventional link sharing arrangement.

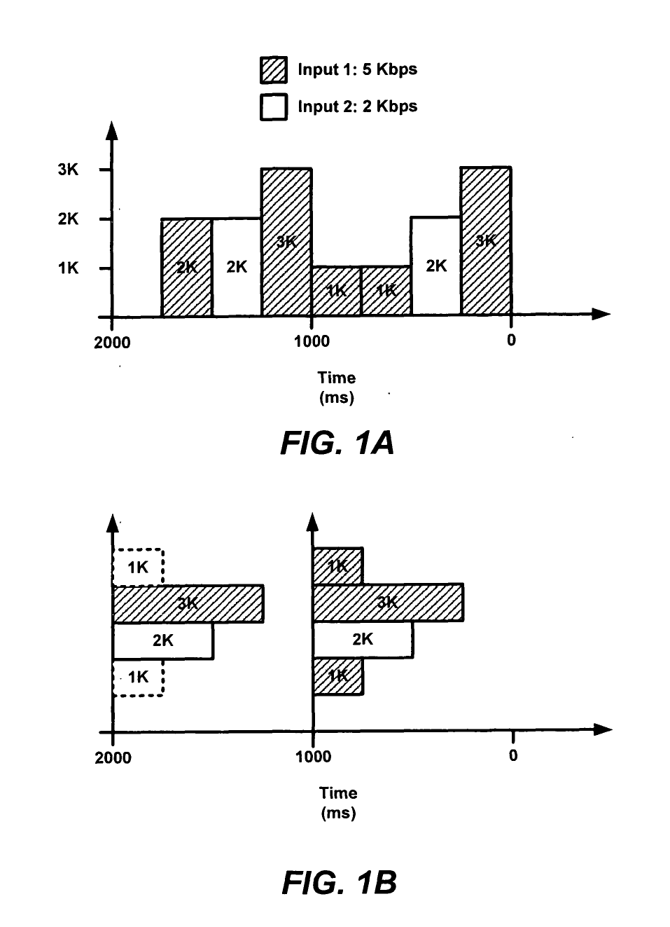

FIGS. 2A and 2B illustrate the structure of Network Abstraction Layer (NAL) units.

FIG. 3 is a block diagram of an exemplary embodiment of a multiplexer system in accordance with the present invention.

### DETAILED DESCRIPTION

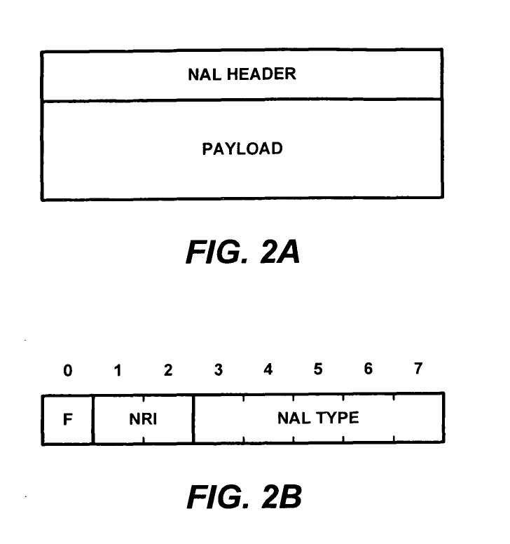

As is well known, H264/Advanced Video Coding (AVC) bit streams are transported as Network Abstraction Layer (NAL) units (See RTP Payload Format for H.264 Video, RFC 3984, February 2005.) Each NAL unit has a NAL header which describes the NAL type. The structure of a NAL unit is shown in FIG. 2A. A NAL header is shown in FIG. 2B. As shown in FIG. 2B, the header contains a five-bit TYPE field, which indicates the NAL unit type value, a two-bit NAL_ref_idc (NRI) field, and an eighth, forbidden zero bit F.

Per RFC 3984, the two-bit NAL_ref_idc field indicates a priority value for the NAL unit. A value of 00, for instance, indicates that the content of the NAL unit is not used to reconstruct reference pictures for inter-picture prediction. Such NAL units can be discarded without risking the integrity of the reference pictures. Values greater than 00 indicate that the proper decoding of the NAL unit is required to maintain the integrity of the reference pictures. Also per RFC 3984, a value of 0 for the F bit indicates that the NAL unit type octet and payload should not contain bit errors or other syntax violations. A value of 1 indicates that the NAL unit type octet and payload may contain bit errors or other syntax violations. The decoder may react accordingly.

In an exemplary embodiment, the present invention provides a multiplexer that is NAL-aware. In other words, a multiplexer in accordance with the present invention understands the NAL type of video units and multiplexes them accordingly. This allows a multiplexer in accordance with the present invention to provide improved multiplexing of audio/video streams, such as H264/AVC streams.

An H264/AVC bit stream may contain different compressed frame types according to the profiles in use. For example, a baseline profile stream can have only I (Intra) and P (Predictive) frames whereas main and extended profile streams can have I, P and B (Bi-directional) frames. NAL units containing different frames will have different NAL type values. A partial listing of defined NAL type values is shown in Table 1 below (ITU-T Recommendation H264, Advanced video coding for generic audio visual services, May 2003.)

TABLE 1

| NAL type | Content of NAL Unit |
|---|---|
| 1 | Coded slice of a non-IDR picture |
| 5 | Coded slice of an IDR picture |
| 7 | Sequence Parameter set |
| 8 | Picture Parameter set |
| 13 . . . 23 | Reserved |

In any H264/AVC stream, an Instantaneous Decoding Refresh (IDR) picture is more important than non-IDR frames as far as the decoder is concerned. Moreover, Sequence Parameter sets and Picture Parameter sets are required for the correct decoding of an entire stream. As such, H264 decoders can conceal the errors caused by losing a ‘P’ frame or a ‘B’ frame better than errors caused by losing an IDR frame, and may be unable to decode a stream altogether by losing a Sequence Parameter set or a Picture Parameter set.

In an exemplary embodiment of the present invention, NAL type values 7 and 8 have the highest priority, followed by 5 and 1 and finally, 13-23. The range 13-23 can be divided further into Enhance IDR and Enhance non-IDR, with Enhance IDR having a higher priority.

A Scalable Video Coding (SVC) encoded bit stream will contain NAL units corresponding to multiple layers of encoding: for example, a base layer having low resolution frames and an enhancement layer having high resolution frames, in the case of spatial scalable coding. (See ISO/IEC 14496-10|ITU-T H.264-Annex G (2007), Scalable Video Coding.) In a typical spatial scalable coded stream, which has both base layer and enhancement layer NAL units, the base layer units can be considered more important than the enhancement layer NAL units since reproduction of video is possible only by decoding the base layer. Note that the base and enhancement layers can be sent in the same network stream or in different network streams.

The NAL type values in the range 13-23 can be used for sending enhancement layer NAL units in an SVC encoded bit stream. An enhancement layer NAL unit can thus be identified by looking at the NAL type value (i.e., 13-23). Different frame types within an enhancement layer of a SVC stream can use different NAL type values.

In an exemplary embodiment, the present invention provides a multiplexer that parses the headers of NAL units and determines their relative importance by looking at the NAL type values therein. The NAL-aware multiplexer can thus determine the NAL units that are more important for stream decoding. The multiplexer can then use this information to pass NAL units to its output accordingly. Thus, where bandwidth is limited, the multiplexer will pass all or some of the more important NAL units while dropping all or some of the less important NAL units. A NAL-aware multiplexer is described in greater detail in a related patent application entitled NAL-AWARE MULTIPLEXER, Attorney Docket No. PU080116.

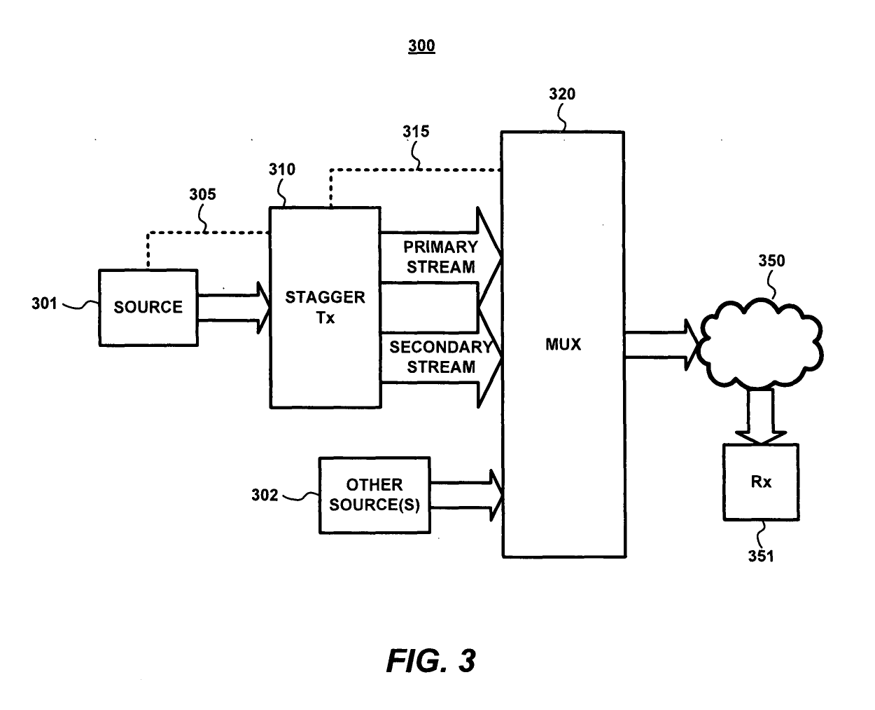

FIG. 3 is a block diagram of a network arrangement 300 for illustrating an exemplary embodiment of the present invention. As shown in FIG. 3, a multiplexer (MUX) 320, such as a statistical multiplexer, is arranged downstream of a stagger transmitter 310, which, in turn, is arranged downstream of a data source 301, such as a video encoder. Typically, other sources 302 will also feed the MUX 320, and may include stagger transmitters or other network elements. The source 301 provides an original stream of units to the stagger transmitter 310, which, in turn, provides a staggercast transmission to the MUX 320. The output of the MUX 320 is coupled to a bandwidth-limited transmission channel carried by a network 350 to a receiver 351, such as a video decoder.

During normal operation, the staggercast transmission from the transmitter 310 to the MUX 320 comprises two streams. One stream, the primary stream, corresponds to the original stream from the source 301 and the other stream, the secondary stream, is a redundant copy of the primary stream. Note that for the purposes of the present invention, the headers of the primary stream units can be different from the headers of the corresponding original stream units, and the headers of the secondary stream units can be different from the headers of the corresponding primary stream units. Thus a primary stream unit may contain a payload that is the same as the payload of the corresponding original stream unit and a secondary stream unit may contain a payload that is the same as the payload of the corresponding primary stream unit.

The secondary stream is time-shifted or staggered relative to the primary stream, in which case it will be referred to as a “staggered” stream. For example, the primary stream may be delayed with respect to the secondary stream. This allows the receiver 351 to pre-buffer units of the staggered stream so that they may replace corresponding units in the primary stream that may have been lost or corrupted in transmission.

Preferably, the stagger transmitter 310 is capable of dropping selected units from each of the primary and staggered streams. Preferably, the MUX 320 is also capable of dropping selected units received at its inputs. As such, the MUX 320 may output all, part of, or none of the units in the primary stream and all, part of, or none of the units in the staggered stream, to a transmission network 350 for ultimate reception by the receiving device 351. As mentioned, the receiving device 351 can use the staggered stream, to the extent that any of it is forwarded by the MUX 320, to perform error recovery in case all or a portion of the original stream is lost in transmission.

Note that in the arrangement shown in FIG. 3, the source 301 provides a single stream, which is then re-transmitted by the transmitter 310 as part of a staggercast transmission of two streams. This, however, is only one of a variety of possible arrangements to which the present invention can be applied. For example, an arrangement in which the source 301 generates a staggercast transmission (with two streams) which is then received and re-transmitted by one or more staggercast transceivers in series could also be used with the present invention.

Additionally, in some applications, a secondary stream as contemplated by the present invention may already be available, as opposed to generating it with a stagger transmitter, as shown. For example, a specification may define multiple profiles for the transmission of content to mobile devices. These profiles can vary from very low resolution/frame rate/bitrate streams for viewing on simple mobile phones with small screens to higher resolution/frame rate/bitrate streams for mobile devices better capable of presenting video (having a larger screen, more powerful decoder, etc.) A system may simultaneously transmit a given video program in both profiles on the same channel so that users of either type of device may receive video that is optimal for their respective devices.

The MUX 320 receives the primary and secondary streams from the transmitter 310 and the other sources 302 and switches them through to its output for serial transmission via the network 350 to the receiver 351. The bandwidth requirements of the various sources served by the MUX 320 will vary and may exceed the available bandwidth at the output of the MUX. When there is sufficient available bandwidth, the MUX 320 will be able switch both streams from the stagger transmitter 310 through to its output. In cases where the available channel bandwidth is insufficient, however, the MUX 320 may not be able to send both streams in their entirety. The MUX 320 could drop some units in either or both streams due to this constraint.

As shown by dotted line 315, a communication path is provided between the MUX 320 and the stagger transmitter 310. An additional communication path between the stagger transmitter 310 and the source 301 is also preferably provided, as represented by dotted line 305. In an exemplary embodiment, the paths 305, 315 are out-of-band and may be provided for in accordance with a protocol or using control messages.

In a first exemplary embodiment, when the MUX 320 determines that the bandwidth demand of the various input streams to the MUX 320 exceeds the available bandwidth, the MUX 320 informs the stagger transmitter 310 of this condition via the path 315. The MUX 320 can provide the stagger transmitter 310 with different amounts of information. For example, the MUX 320 can simply inform the stagger transmitter 310 that the bandwidth demand of the various input streams to the MUX 320 exceeds the available bandwidth, or it may also indicate by how much. The stagger transmitter 310 can then determine which units to drop in the primary stream, the staggered stream, or both, in order to fit the inputs in the available limited bandwidth. In the case of NAL units, the determination of which units to drop is based on a comparison of NAL units which takes into account the relative importance of NAL units within the stream, across multiple streams (in the case of SVC), as well as NAL unit size. As such, the determination of relative importance is done at the stagger transmitter level itself; i.e., the stagger transmitter 310 can drop the less important NAL units itself.

The stagger transmitter 310 thus provides an additional layer in bandwidth control. Because the stagger transmitter 310 provides redundant streams, it can also control the amount of redundant stream bandwidth based on feedback from the MUX 320 to help the MUX in further controlling bandwidth.

In a further exemplary embodiment, instead of or in addition to dropping selected units itself, the stagger transmitter 310 can communicate with the MUX 320, via path 315, information that will help the MUX 320 to determine which units to drop in order to meet bandwidth constraints. For example, the stagger transmitter 310 may manipulate Type of Service (TOS) information contained in the headers of units. The MUX 320 can then parse the TOS information of units and drop units in accordance with their respective TOS settings. In this embodiment, instead of dropping selected units itself, the stagger transmitter 310 sends some or all units to the MUX 320 but manipulates the TOS information of all or some of the units so that the MUX 320 can drop or pass units in accordance with their TOS information. In the case of NAL units, the stagger transmitter 310 can set the TOS information of such units in accordance with their NAL type values, discussed above, so that more important units will receive priority over less important units. This is described in greater detail in a related International Patent Application entitled STAGGERCASTING METHOD AND APPARATUS USING TOS INFORMATION, Attorney Docket No. PU080104. In addition to or as an alternative to using TOS information, the stagger transmitter 310 can use other means to communicate to the MUX 320 which units to drop. In an exemplary embodiment, the stagger transmitter 310 can provide the MUX 320 with a list of the RTP sequence numbers of units to drop.

As such, whether dropped by the stagger transmitter 310 or MUX 320, the least significant NAL units will be discarded before the important ones, thus lessening the impact of the bandwidth limitation on the quality of decoded video. Moreover, since a staggered stream is redundant, it will typically be given lower priority than a primary stream. This way there is a compromise between error recovery and sustainable data delivery. There may be cases, however, where depending on their relative importance, it may be desirable for the MUX 320 to drop units in the primary (or only) stream from one source while passing units in a staggered stream from another source.

As mentioned above, a communication path 305 between the stagger transmitter 310 and the data source 301 is also preferably provided. The path 305 can be used, for example, to send control messages from the stagger transmitter 310 to the data source 301. Such control messages may contain, for example, information about a bandwidth condition at the MUX 320, such as an indication that the bandwidth demand at the MUX exceeds the bandwidth available, and/or by how much. The source 301, in turn, can use this information to control its output bandwidth accordingly. So, for example, if the stagger transmitter 310 sends a control message to the data source 301 that the bandwidth demand at the MUX 320 exceeds the available bandwidth by N kbps, the data source may reduce its output by N kbps.

It is understood that the above-described embodiments are illustrative of only a few of the possible specific embodiments which can represent applications of the invention. Numerous and varied other arrangements can be made by those skilled in the art without departing from the spirit and scope of the invention.

1. A method of multiplexing streams of data units comprising:
receiving at a stagger transmitter an original stream of data units from a data source;
generating at the stagger transmitter a primary and a secondary stream of data units based on the original stream of data units;
communicating to the stagger transmitter information about a bandwidth condition at a multiplexer downstream of the stagger transmitter; and
dropping a subset of the plurality of data units in accordance with the bandwidth condition at the multiplexer.

2. The method of claim 1, wherein the step of dropping a subset of the plurality of data units is performed at the stagger transmitter.

3. The method of claim 1, comprising determining at the stagger transmitter an importance of the data units, wherein the step of dropping a subset of the plurality of data units is performed in accordance with the importance of the data units.

4. The method of claim 1, wherein the information about the bandwidth condition is contained in one or more control messages.

5. The method of claim 1, comprising:
communicating data unit information from the stagger transmitter to the multiplexer, wherein the step of dropping a subset of the plurality of data units is performed at the multiplexer in accordance with the data unit information.

6. The method of claim 1, comprising:
sending control messages from the stagger transmitter to the data source; wherein the data source can vary its output bandwidth based on control messages received from the stagger transmitter.

7. The method of claim 3, wherein the data units include Network Abstraction Layer (NAL) units, each NAL unit containing a header, the header containing a content type of the NAL unit; wherein determining an importance of a data unit includes identifying the content type of an NAL unit.

8. The method of claim 1, wherein the original stream is at least one of an H264/AVC stream and an SVC stream.

9. Apparatus comprising:
a source of packets for providing an original stream of packets, each packet comprising a payload for conveying video and a header for conveying identifying information about the video payload; and
a staggercasting transmitter for providing a primary stream of packets corresponding to the original stream of packets and at least one secondary stream of packets corresponding to the original stream of packets, wherein there is a time offset between the primary stream and the at least one secondary stream and wherein the staggercasting transmitter receives information from a multiplexer about a bandwidth condition and drops a subset of the packets in accordance with the bandwidth condition.

10. The apparatus of claim 9, wherein the information about the bandwidth condition is contained in one or more control messages.

11. The apparatus of claim 9, wherein the staggercasting transmitter drops the subset of packets in accordance with the importance of the packets.

12. The apparatus of claim 11, wherein the packets include Network Abstraction Layer (NAL) units, each NAL unit containing a header, the header containing a content type of the NAL unit; and wherein determining an importance of a packet includes identifying the content type of an NAL unit.

13. The apparatus of claim 9, wherein the original stream is at least one of an H264/AVC stream and an SVC stream.
